(19) United States
(12) Patent Application Publication
(10) Pub. No.: US 2004/0035416 A1
(43) Pub. Date: Feb. 26, 2004

(54) Climate-controlled chamber

(76) Inventor: Lothar Gluderer, Schwaz (AT)

Correspondence Address: LERNER AND GREENBERG, P.A., POST OFFICE BOX 2480, HOLLYWOOD, FL, 33022-2480, US

(21) Appl. No.: 10/629,923

(22) Filed: Jul. 30, 2003

Related U.S. Application Data
(63) Continuation of application No. PCT/AT02/00012, filed on Jan. 16, 2002.

(30) Foreign Application Priority Data
Jan. 30, 2001 (AT) A 150/2001

(51) Int. Cl. A61G 10/02; A62B 31/00

(52) U.S. Cl. 128/202.13; 422/120; 128/205.26

(57) ABSTRACT

A chamber or living unit for persons has a control device and a processor that controls climate conditions in the chamber that are different from ambient conditions. Biosensors are connected to the control device, specifically the processor, for the purpose of detecting body parameters like temperature, pulse, skin resistance, blood pressure, and so on, of a body that is in the chamber.

### CROSS-REFERENCE TO RELATED APPLICATION:

This application is a continuation of copending International Application No. PCT/AT02/00012, filed Jan. 16, 2002, which designated the United States and which was not published in English.

### BACKGROUND OF THE INVENTION

### FIELD OF THE INVENTION

The invention relates to a device with a chamber or living unit for persons with a control device and a computer that controls climatic conditions in the chamber that are different from ambient conditions.

A number of different climate chambers or apparatuses for generating different climatic conditions are known, which consist substantially of a chamber or a sealed unit where the atmosphere is controlled by control devices. German published patent application DE 44 20 908 A1 describes a living and treatment unit for persons wherein climate factors inside the unit can be controlled by a control device. What is meant by climate factors is specific air temperatures or humidities but also other chemical physical parameters such as substances or even electromagnetic radiation that act on a person inside the unit. The individual values are monitored with respect to specified climate factors in the interior of the unit by means of measuring sensors that project into this unit, which transmit these values to the control device, where they are calculated accordingly and compared to the target values that have been set. An automatic timed modification of individual climate factors during a treatment period in which a person resides inside the unit is also possible through the selection of a corresponding operating program. This operating program is stored in a computer, it being possible to input new and different program routines or to modify the stored program sequences for the overall climate or for individual climate factors in the unit.

U.S. Pat. No. 5,935,516 and corresponding international (PCT) application WO 97/09024 describes a device and method for creating conditions resembling the environment, whereby the device comprises a sealed airtight chamber into which oxygen, carbon dioxide, water, or other substances can be conducted. The apparatus further comprises control devices that can control the atmosphere, for instance the oxygen concentration, the pressure, the temperature, and the humidity inside the chamber. It is also possible to generate a magnetic field inside the chamber whose intensity and orientation can also be controlled by a control device.

These prior arty climate apparatuses and climate-controlled chambers or climate units demonstrate a perfect controlling of the climate factors or atmospheric conditions that exist or that are to be generated in the chamber or unit; however, they are adaptable to the individual needs of the person in the chamber only to a limited degree. Monitoring and modification is only possible with the aid of measuring devices in the chamber, but these do not directly contact the person. A further disadvantage of the known climate devices is that the body or person in the chamber cannot influence the control of the climate factors, because such control is only possible outside the chamber by means of computers or other devices.

### SUMMARY OF THE INVENTION

It is accordingly an object of the invention to provide a climate-controlled chamber, which overcomes the above-mentioned disadvantages of the heretofore-known devices and methods of this general type and which allows the person located in the chamber to directly modify or monitor the climate factors or conditions surrounding the body.

With the foregoing and other objects in view there is provided, in accordance with the invention, a climate-controlled chamber assembly, comprising:

a device forming a chamber for receiving a person;

a control device for controlling climatic and ambient conditions in the chamber;

biosensors disposed to detect body parameters of a body of the person located in the chamber and connected to the control device;

wherein the climatic and ambient conditions in the chamber are regulated by the control device directly based on the body parameters detected by the biosensors.

In accordance with an added feature of the invention, the biosensors are configured to detect parameters such as a temperature, a pulse, a skin resistance, and a blood pressure of the person in the chamber.

In a preferred embodiment, the control device includes a processor (computer), and the processor and the biosensors are connected in a closed-loop control system for regulating the climatic and ambient conditions in the chamber.

In other words, the inventive device of the above cited type is characterized in that biosensors for detecting body parameters of the person in the chamber, such as body temperature, pulse, skin resistance, blood pressure, and so on, are provided, which are connected to the control device or the computer, as the case may be.

The invention thus enables an interaction between the body parameters of the person(s) in the chamber and the climate factors surrounding her and affecting her. This is accomplished with the aid of the biosensors, which encompass essentially known measuring devices such as thermometers, pulse and blood pressure sensors, devices for measuring electrical resistances like skin resistance, surface electrodes, and other measuring devices for sensing body signals like EKG, EEG, and so on. These signals, that is to say, these body parameters, are conducted to the control device comprising the computer, whereby the settings of the climate factors in the chamber can be modified depending on the body parameters. A modification of individual or multiple climate factors (meaning essentially the environmental conditions inside the chamber) can occur by means of the computer, for instance a digital computer, of the control device. Various operating programs can be retrieved by means of this computer, which set different sequences for an overall climate that is to be generated in the chamber, for instance a lowering of pressure or humidity and elevating of the temperature corresponding to a “desert climate”, an acoustic irradiation, an illumination, and so on. The control device can implement these modifications of individual climate factors or overall routines in the climate chamber. The control device is equipped with known devices which are capable of releasing, conditioning, or mixing gaseous and/or liquid media, so that these can be fed into the chamber in controllable form. Examples of the devices are pressure vessels, mixing chambers, pumps, compressors, filtering devices, heat exchangers, humidifiers, containers for liquid or gaseous media, inflow and outflow lines with appertaining flow regulators such as valves, measuring devices like temperature sensors, pressure sensors, content meters, ionization meters, and so on. Simple and complex processes that are required in order to give liquid and/or gaseous media the form in which they are to be released into the chamber can be generated in these devices. In addition, the control device can be equipped with illuminating bodies, sound sources, scenting devices, and so on. The illumination bodies can provide various colors or color patterns, potentially in conjunction with a fitting acoustic irradiation and/or aromatization.

In the simplest case, these processes can occur as follows: Liquid media such as distilled water are conducted in doses from a supply container into a mixing chamber, where they are charged with gases such as oxygen, nitrogen, noble gases or gas blends, scents, essences, or salts. The gaseous media can also be pressure controlled or blended with other gasses and then fed in. The resulting liquid-gas mixture can then be heated, cooled, ionized, or otherwise processed, either immediately or during further conduction, ultimately in order to be fed to the chamber in controlled form and to generate or modify corresponding climate factors. These operations of the control device can occur under computer control individually, sequentially, in parallel, consecutively, separately, or mutually dependently. It is thus possible to impose a relation among individual climate factors such that different conditions can be created, such as sea climate, mountain climate, and so on, and furthermore to set various light, weather, and sound conditions such as sunshine, fog, snowfall, rain, storm, and so on. In addition, changes or deviations of the physical parameters are detected by means of the biosensors via the direct connection to the person who is exposed to the climate conditions and weather conditions in the chamber and immediately transmitted to the computer. In the computer, the values of the physical parameters that have been induced by the sequences of defined climate conditions or weather conditions are compared to predetermined values, and, depending on registered deviations, the control device responds by providing for abatement or intensification of the climate factors in the chamber.

The chamber or living unit itself can represent a known or conventional climate chamber which can accept the operations of the gaseous or liquid media, sound sources, illumination bodies, and so on, which are generated and monitored and controlled by the control device. The chamber or living unit is correspondingly equipped with corresponding devices such as measuring units, inflow and outflow lines, jets—which can be used for spraying, humidifying or aromatization—illuminating bodies, sound sources such as loudspeakers, fans, and so on. The inventive chamber or living unit advantageously comprises a separate control room which is equipped with control devices for additionally monitoring the climate factors or conditions. These can encompass thermometers, barometers, hygrometers, manometers, concentration meters, and so on, as well as control devices for illumination and acoustic irradiation. It is additionally advantageous when the control room comprises a backup control that can effect an interrupt or can influence the processes of the control device in the event of an emergency or disturbances, so that unwanted or even dangerous climate factors or conditions from the standpoint of the person in the chamber can be avoided.

It is also advantageous when a sluice room is provided, in which a person who enters or leaves the chamber or living unit can “acclimatize”.

According to an expedient embodiment of the chamber or living unit, the biosensors are connected to the control device, specifically the computer, by radio. Such a connection makes possible a highly user-friendly utilization of the inventive chamber. Lines, specifically lines for transmitting the body parameters that are detected by the biosensors, can be replaced by this radio connection. A conventional radio connection can be utilized, whereby ordinary communication to the computer, i.e. the control device, must be guaranteed.

It is particularly favorable when the control device controls the composition of gaseous and/or liquid media that are to be fed to the chamber or living unit. The composition, for instance the concentration, saturation, and mix ratio, can be provided by the above described processes. The devices of the above mentioned control device serve this purpose, whereby they are activated according to the routines that are stored in and retrieved from the computer.

It is also advantageous when the control device regulates the pressure or flow volume of the gaseous and/or liquid media. In such an embodiment, particular climate factors such as underpressure or overpressure can be set in the chamber. When a person is subjected to these conditions in the chamber, reactions or changes of physical parameters are brought about in the body of this person, which are detected by the biosensors and transmitted to the computer of the control device. There, the values are compared to the prescribed target values. If modification, i.e. increasing or decreasing, of the underpressure in the chamber is needed, this is transmitted to the devices that are provided in the control device and implemented accordingly, so that the underpressure in the chamber is adjusted.

It is advantageously also provided that the control device controls the illumination and/or acoustic irradiation of the chamber.

Other features which are considered as characteristic for the invention are set forth in the appended claims.

Although the invention is illustrated and described herein as embodied in a climate chamber, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view of the chamber or living unit according to the invention; and

FIG. 2 is a cross-section taken through the chamber or living unit according to the invention.

### DESCRIPTION OF THE PREFERRED EMBODIMENTS

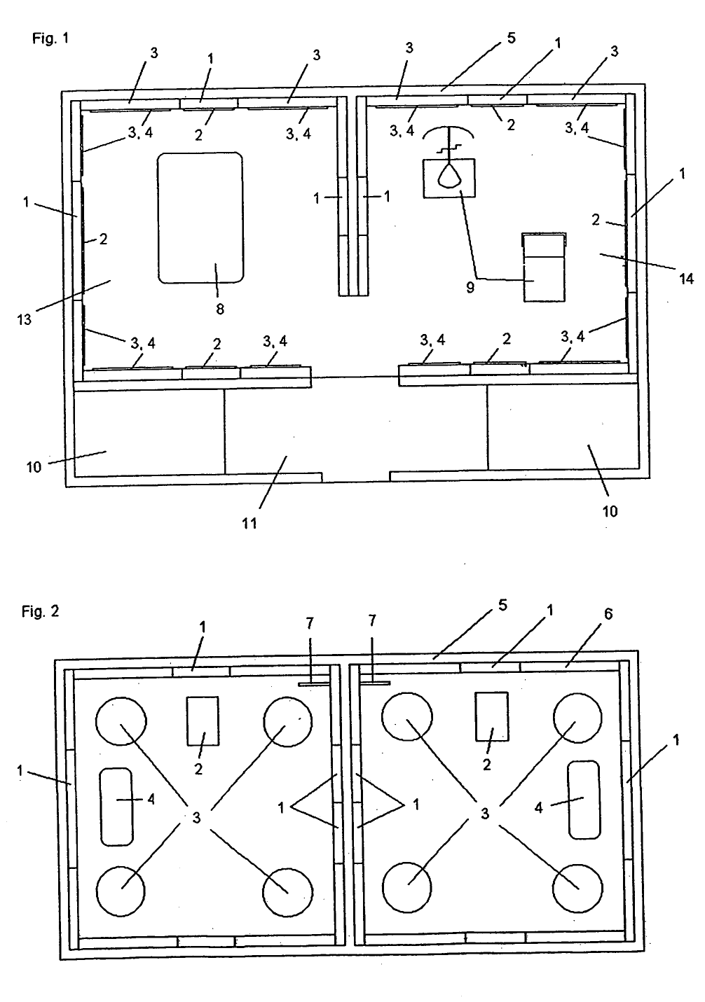

Referring now to the figures of the drawing in detail and first, particularly, to FIG. 1 thereof, there is shown a chamber (climate-controlled biochamber, mini-biosphere, etc.) according to the invention which comprises three mutually isolated regions in the front section, that is to say, in the entry region of the chamber. The two outer regions 10 which are disposed on the margin represent control rooms that are equipped with measuring devices such as thermometers, barometers, hygrometers, manometers, and so on for the purpose of monitoring the climate factors in the chamber. A backup control is further provided in the control rooms, which can be utilized in the event of emergencies or functional disturbances of the inventive chamber. A sluice room 11 is provided between the two control rooms, which serves for acclimatizing or adapting a body of a person to the climatic conditions in the chamber but also outside the chamber. Adjoining the entry region in FIG. 1 is the central region of the chamber, whereby this is divided into two additional regions, a left region 13 and a right region 12. A couch 8 and two exercise machines 9 are schematically represented in the two central regions. A dividing wall through which shafts 1 extend divides the central region of the chamber into the left and right regions according to FIG. 1.

Another important feature of the inventive apparatus according to FIG. 1 is the double wall which surrounds the chamber, specifically the central region thereof. The exterior wall 5 of the double wall consists of an insulating material, so that the climate factors prevailing in the chamber can be maintained. The interior wall 6 of the chamber, particularly the central region of the chamber, is likewise provided with shafts 1 that can serve as inflow and outflow lines for pressure or suction fans 2, whereby controllable connections to the central region of the chamber are provided. The interior wall additionally comprises illuminating bodies 3 for illuminating the interior central region. The illuminating bodies can be equipped with various color filters, devices for generating color patterns, and so on. The illuminating bodies can also be influenced by the control device and the acknowledgment of the biosensors with respect to brightness, color intensity, and wavelength of the emitted light as well as the selection and movement of the color patterns. Similarly, the interior wall can also comprise sound sources 4 for the acoustic irradiation of the interior central region, whereby the acoustic sources can also be influenced by the control device and the acknowledgment of the biosensors with respect to tone level, melody and volume of the sound. The influence of light, particularly colored light, as well as tones brings about measurable reactions in the body in the chamber, for instance a change of skin resistance. This change can be registered by the biosensors, and an optimal environment for the body in the chamber can be created. Chamber, climate chamber, or living unit mean correspondingly equipped rooms in hotels and wellness or fitness centers which are suitable for temporary or long-term living. Such rooms can also be partly filled with water like a swimming pool, whereby the water can be influenced by the control device in conjunction with the biosensors with respect to composition (e.g. addition of gases such as O₂, N₂ or CO₂, aromas, or salts) and/or temperature.

The interior wall 6 comprises additional shafts 1, which comprise devices of the control device such as jets, inflow and outflow lines, lines to the illuminating bodies and acoustic sources, and so on.

FIG. 2 represents a cross-section of the inventive chamber, particularly the central region of the chamber. Like in FIG. 1, the central region here is equipped with shafts 1 through a dividing wall for accepting devices of the control device, whereby additional mobile plug connections 7 for connecting the biosensors are represented. The exterior wall 5 of the double wall surrounding the chamber consists of an insulating material and a shaft that serves for gas circulation. The interior wall 6 of the double wall is again furnished with shafts 1, which comprise devices of the control device for setting individual climate factors or more complex climate conditions in the chamber. Also provided in the inner wall of the double wall are sensors, measuring units, jets, inflow and outflow lines, and supply lines for light and sound sources and so on. All said devices in the double wall are connected to the control device. As in FIG. 1, the shafts 1 can also serve as inflow and outflow lines for pressure or suction fans 2. Also provided in or at the double wall are light sources 3 and sound sources 4.

When a person is located in the central region for the chamber, and the inventive chamber is activated, a routine for generating and monitoring an underpressure must be stored in the computer of the control device and retrieved. According to the target values defined in such a routine, the devices of the control device that are provided for implementing the routine are prompted to generate the underpressure in the chamber. The person in the chamber is exposed to this controlled underpressure. Biosensors such as a measuring device like a pulse oximeter for measuring the oxygen saturation in the blood are applied to the body of the person in the chamber in direct contact therewith and continuously detect the oxygen saturation in the blood. These registered values are transmitted to the computer of the control device, which processes the incoming values and compares them to the target values of the routine that is stored in the computer. If an unwanted or excessive reaction is brought about in the body of the person who is exposed to the underpressure, individual factors, in this case the oxygen partial pressure, can be immediately modified or adapted by means of the control device.

That way, the person in the chamber can perform various activities such as sports while the applied biosensors monitor particular body parameters, whereby the individual climate factors or conditions are automatically modified if predetermined values are exceeded. Furthermore, the inventive chamber with the control device makes possible the setting of various climate conditions such as sea climate and mountain climate, as well various weather and environmental conditions like snowfall, fog, light relations, sound effects, and so on, and their modification in dependence on body parameters, whereby the body of the exposed person can be effectively and optimally adapted to various prescribed climate conditions.

I claim:

1. A climate-controlled chamber assembly, comprising:
a device forming a chamber for receiving a person;
a control device for controlling climatic and ambient conditions in said chamber;
biosensors disposed to detect body parameters of a body of the person located in said chamber and connected to said control device;
wherein the climatic and ambient conditions in said chamber are regulated by said control device directly based on the body parameters detected by said biosensors.

2. The chamber assembly according to claim 1, wherein said biosensors are configured to detect parameters selected from the group consisting of a temperature, a pulse, a skin resistance, and a blood pressure of the person in said chamber.

3. The chamber assembly according to claim 1, wherein said control device includes a processor, and said processor and said biosensors are connected in a closed-loop control system for regulating the climatic and ambient conditions in said chamber.

4. The chamber assembly according to claim 3, wherein said biosensors are connected to said processor via a radio link.

5. The chamber assembly according to claim 1, wherein said biosensors are connected to said control device via a radio link.

6. The chamber assembly according to claim 1, wherein said control device is configured to control a composition of fluidic media supplied to said chamber.

7. The chamber assembly according to claim 6, wherein said control device is configured to control a pressure or a flow volume of the fluidic media.

8. The chamber assembly according to claim 1, wherein said control device is configured to control at least one of an illumination and an acoustic irradiation in the chamber.
